(19) United States
(12) Patent Application Publication
(10) Pub. No.: US 2025/0392072 A1
(43) Pub. Date: Dec. 25, 2025

(54) MODULAR ELECTRICAL CONNECTION DEVICE

(71) Applicant: SINBON ELECTRONICS COMPANY LTD., New Taipei City (TW)

(72) Inventors: Hsin-Feng LIN, New Taipei City (TW); Shen-Yi HSIEH, New Taipei City (TW); Li-Wen CHEN, New Taipei City (TW)

(21) Appl. No.: 18/752,222

(22) Filed: Jun. 24, 2024

(51) Int. Cl. H01R 13/506; H01R 13/514; H01R 24/40

(52) U.S. Cl. CPC H01R 13/506; H01R 13/514; H01R 24/40

(57) ABSTRACT

The present invention relates to a modular electrical connection device comprising a male connector and a female connector, the male connector and the female connector each have a respective cable module in a housing, the cable module comprises multiple cable terminals and a fixing base for fixing the cable terminals, each cable terminal comprises a terminal head and a coaxial cable, wherein the terminal heads are fixed to the fixing base respectively, and the coaxial cable is capable of transmitting single-ended or differential-pair signals. The cable terminals for transmitting single-ended or differential signals are modularized together with the fixing base. The fixing base, the terminal head and/or the coaxial cable can be individually replaced to meet the needs of various application scenarios or terminal usage requirements.

### BACKGROUND OF THE INVENTION

### Field of the Invention

The present invention relates to an electrical connection device, in particular to a modular electrical connection device.

### Description of the Related Art

Systems or devices related to electrical signals must take into consideration characteristics of signal transmission, such as frequency, rate or distance, etc. With respect to various application scenarios, the development at the system ends should choose proper electrical connection devices conforming to the signal transmission characteristics; for example, there are single-ended transmission and differential transmission. The single-ended transmission means that there is a signal end and a reference end, and usually the reference end is a ground end, so accordingly the signal is transmitted only on the single end. The single-ended transmission has advantages in both low-cost of use and lower spatial requirement of application environment; however, the single-ended transmission has a disadvantage of being susceptible to interference. Unlike the single-ended transmission with only a signal end and a reference end, the differential transmission transmits differential signals in a pair of signal lines, and the differential signals consist of two complementary signals which are of the same amplitude but with opposite phases. Advantages of the differential transmission lie in its anti-interference capability to effectively suppress electromagnetic interferences and maintain timing accuracy; however, the disadvantages of the differential transmission are higher costs due to the use of wire pair and higher spatial occupancy due to larger sizes of the circuit boards at the system ends.

As can be known from the above, as far as the signal transmission mode is concerned, single-end transmission and differential transmission both have their own advantages and disadvantages, and system development must be based on the needs of various application scenarios to choose from single-ended and/or differential signal transmission. For test equipment, it is especially necessary to choose signal transmission modes based on various needs, which requires repeated testing of the signal transmission modes and/or the cables during testing phase.

Currently, medium used to transmit signals is a cable wire. Cable wires are connected to each other through electrical connecting devices which are usually conformed to fixed specifications for specific needs, and it is not possible to change internal parts of the electrical connecting devices to meet the needs of testing. On the other hand, even for electronic products and system equipment used in non-testing applications, when an internal part of the electrical connection device connected to a cable is damaged, the whole device has to be replaced, and cannot be repaired by replacing the internal part.

From the above, it can be known that the existing fixed specification of the electrical connection device cannot meet multitude of needs of the testing scenarios, and even for normal usage, the electrical connection device cannot be repaired in case of internal-part damaging. As a result, there is a need for to find feasible solutions for the above-mentioned issues.

### SUMMARY OF THE INVENTION

Accordingly, the present invention provides a modular electrical connection device, which realizes the purpose of replacing partial component parts to satisfy testing or maintenance needs by modularizing the component parts.

To achieve the forgoing objective, the aforementioned modular electrical connection device comprises a connector, and the connector comprises:

a housing, being hollow and having an end-to-end installation slot; a cable module having a plurality of cable terminals detachably disposed on a fixing base; wherein the fixing base is shape-matched and detachably disposed within the installation slot of the housing, the fixing base has a plurality of terminal holes; each cable terminal has a terminal head and a coaxial cable, the terminal head has a mating end and a wire end, the mating end is passed through the terminal hole of the fixing base, and the wire end is engaged with the coaxial cable.

The present invention utilizes the aforementioned modular design to make the main components of the connector replaceable according to the needs of use, including the housing, the cable module and the cable module’s fixing base, and the cable terminal, wherein the cable terminal can meet the actual needs of the application scenarios by replacing its coaxial cable with a coaxial cable of different impedance and length. The above modular design is not only applicable to test equipment with various characteristics, but also applicable to general electronic products or systems, so as to meet various demands by partially replacing component parts when the electrical connection device itself is damaged or the specifications of the demand are changed.

In order to make the above objects, features and advantages of the present invention more apparent and easier to understand, the following embodiments, together with the accompanying drawings, are described in detail as follows.

### BRIEF DESCRIPTION OF THE DRAWINGS

FIG. 1 is an exploded view of the present invention;

FIG. 2 is an exploded view of a female connector according to a preferred embodiment of the present invention;

FIG. 3 is a cross-sectional view of a female connector according to a preferred embodiment of the present invention;

FIG. 4 is a front view of the female connector according to a preferred embodiment of the present invention;

FIG. 5 is an exploded view of a male connector according to a preferred embodiment of the present invention;

FIG. 6 is a cross-sectional view of a male connector according to a preferred embodiment of the present invention;

FIG. 7 is an assembled appearance view of the present invention;

FIG. 8 is an assembled cross-sectional view of the present invention; and

FIG. 9 is a schematic diagram of a use state of connecting terminals through pogo pin connectors according to the present invention.

### DETAILED DESCRIPTION OF THE INVENTION

The technical solution of the present invention is further described below in conjunction with the accompanying drawings and by means of specific embodiments. In the description of the present invention, it is to be understood that the terms "center", "longitudinal", "lateral", "length ", "width", "thickness", "top", "bottom", "left", "right", "vertical", "horizontal", "top ", "bottom", "inner", "outer", "axial", "radial", "circumferential" and the like indicate orientation or positional relationships based on those shown in the accompanying drawings, and are intended only to facilitate the description of the present invention and to simplify the description, and are not intended to indicate or imply that the device or element referred to must have a particular orientation, or be constructed and operated in a particular orientation and therefore cannot be construed as limitations of the present invention.

Furthermore, the terms "first" and "second" are used for descriptive purposes only and are not to be understood as indicating or implying relative importance or implicitly specifying the number of technical features indicated. Thus, the feature defined with "first", "second" may include one or more such features, either explicitly or implicitly. In the description of the present invention, unless otherwise specified, "more than one" means two or more.

In the description of the present invention, it is to be noted that, unless otherwise expressly specified and limited, the terms "mounted", "connected", and "connecting" are to be understood in a broad sense. For example, it may be a fixed connection, a removable connection, or a connection in one piece; it may be a direct connection, an indirect connection through an intermediate medium, or a connection within two elements. For a person of ordinary skill in the art, the specific meaning of the above terms in the present invention may be understood in a specific context.

The present invention is a modular electrical connection device and a basic configuration of the modular electrical connection device is a connector. The connector is mainly detachably provided with a cable module in an installation slot of a housing, and the cable module is mainly provided with a plurality of cable terminals on a fixing base; wherein the fixing base is shape-matched and detachably provided in the installation slot of the housing, and the fixing base has a plurality of terminal holes; each cable terminal has a terminal head and a coaxial cable, the terminal head has a mating end and a wire end, the mating end is fixed in and through the terminal hole of the fixing base, and the wire end is engaged with the coaxial cable.

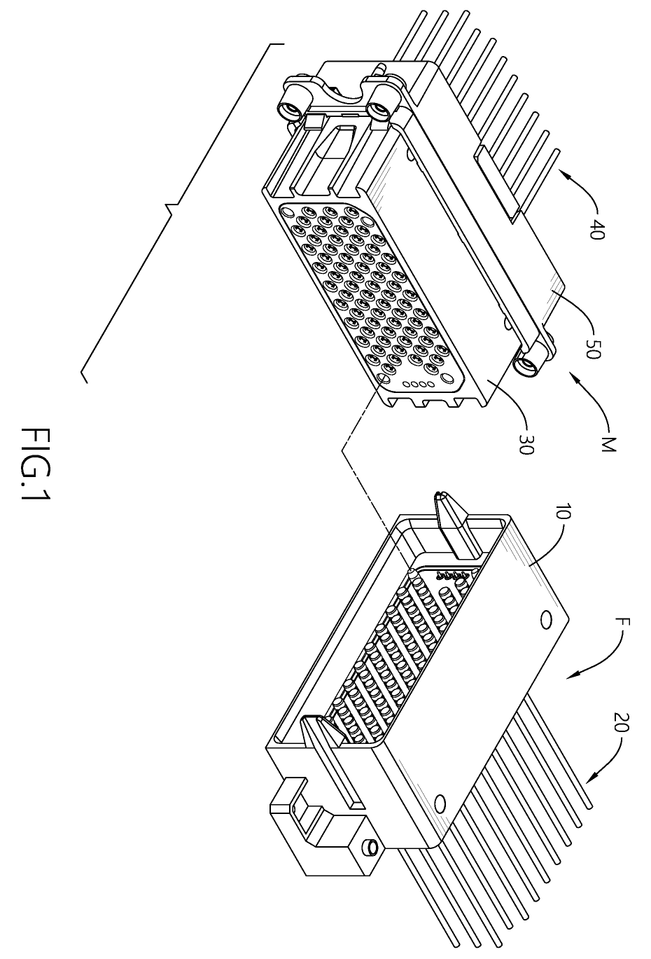

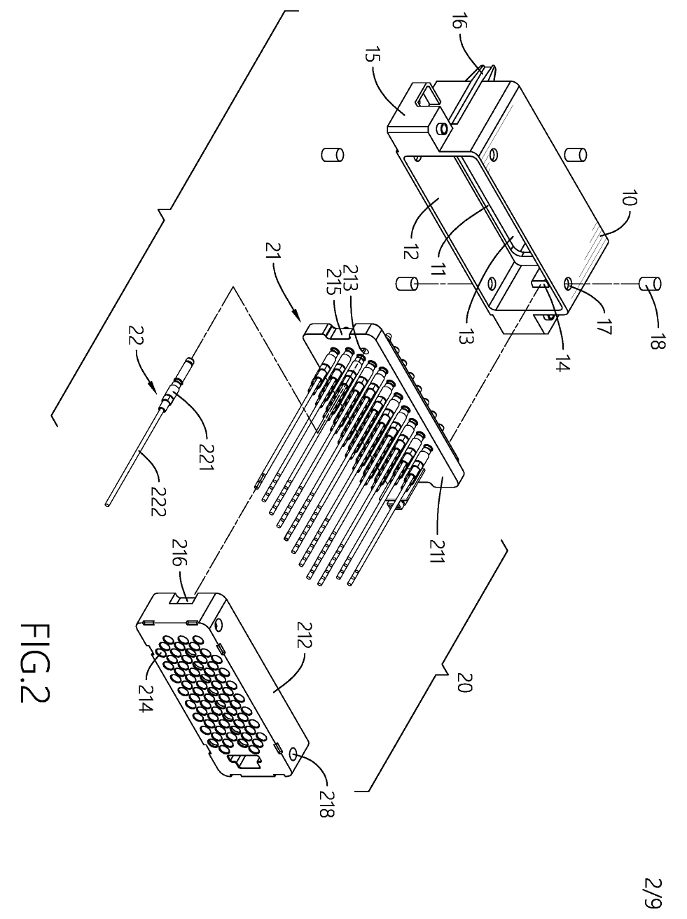

The aforementioned connector can be applied to a female connector and/or a male connector. Firstly, please refer to FIG. 1, which shows a female connector F and a male connector M correspondingly connectable, and a preferred embodiment of the female connector F is shown in FIG. 2, which includes a female housing 10 and a female cable module 20; wherein in this embodiment, the female housing 10 is mainly comprised of a top portion, a bottom portion, and two side portions to form an end-to-end hollow rectangular frame, with a ring-shaped frame 20 formed inside of the female housing10, dividing the interior of the female housing10 into a rear side and a front side, an installation slot 12 is formed on the rear side, and a mating slot 13 is formed on the front side, the installation slot 12 is used to install the female cable module 20, and the mating slot 13 is used for connecting with the male connector M.

In this embodiment, two inner walls of the two side portions of the female housing 10 each have a respective wedge 14 protruding therefrom and into the installation slot 12, to further secure the female cable module 20 assembled in the installation slot 12. Outer side surfaces of the two side portions of the female housing 10 each have a respective fixing base 15 formed thereon, and the fixing base 15 has a fixing hole for securing the female housing 10 to a circuit board or one other carrier. In order to further facilitate the mating of the female connector F with the male connector M, the two side portions of the female housing 10 each have a respective protrusion 16, extending towards a docking direction and with a tapered end. Further, to make the female cable module 20 firmly fixed in the installation slot 12 of the female housing 10, the female housing 10 is formed with more than one wedge hole 17 in the top and bottom portions respectively, and each of the wedge holes 17 is provided with a respective wedge post 18 penetrating into the installation slot 12, to secure the female cable module 20 therein.

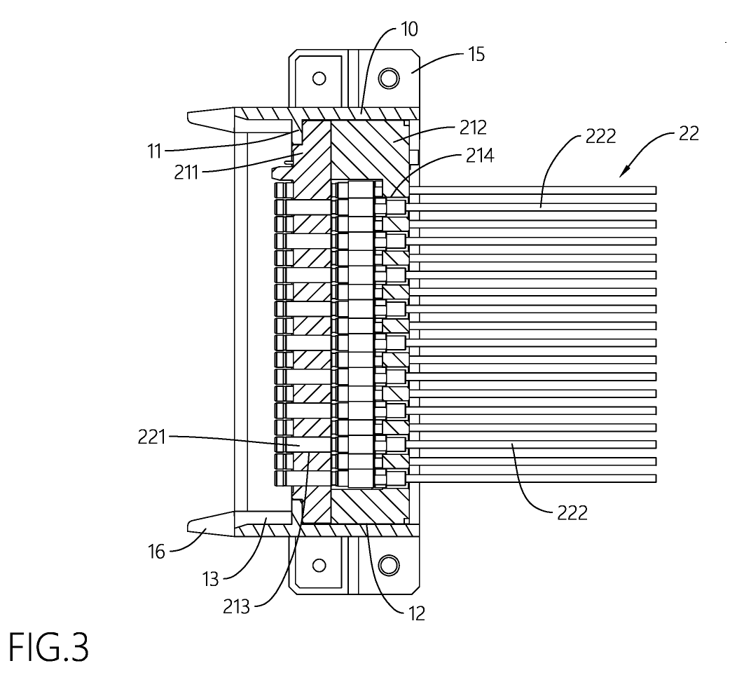

Referring to FIGS. 2 and 3, the female cable module 20 includes a female fixing base 21 and a plurality of female cable terminals 22, the female fixing base 21 is for mounting the plurality of the female cable terminals 22 thereon and the female cable module 20 is shape-matched and detachably mounted in the installation slot 12 of the female housing 10. In this embodiment, the female fixing base 21 comprises a front base 211 and a rear base 212 combined with each other, wherein the front base 211 is formed with a plurality of terminal holes 213 and the rear base 212 is formed with a plurality of cable holes 214, each cable hole 214 corresponds to a respective one of the terminal holes 213 of the front base 211, and the front base 211 and the rear base 212 utilize the terminal holes 213 and the cable holes 214 to secure each female cable terminal 22.

Each of the female cable terminals 22 includes a first terminal head 221 and a coaxial cable 222 respectively, and the first terminal head 221 has a mating end and a wire end. The mating end is disposed in and through the terminal hole 213 of the front base 211, and the wire end is engaged with the coaxial cable 222 which is passed through the cable hole 214 of the rear base 212.

In this embodiment, a wedge groove 215 and a wedge groove 216 are formed respectively on the two side edges of the front base 211 and the two side edges of the rear base 212, and the wedge grooves 215, 216 correspond to the wedges 14 in the female housing 10, and when the female fixing base 21 is installed into the female housing 10, each of the wedges 14 is suitably fitted to the respective wedge grooves 215, 216 to strengthen the fixation of the female fixing base 21 to the female housing 10. Furthermore, the rear base 212 has more than one recessed hole 218 formed on its top and bottom surfaces respectively, and the recessed holes 218 correspond to the wedge holes 17 on the female housing 10, allowing the wedge posts 18 to penetrate therethrough to further strengthen the fixation.

The coaxial cable 222 can be selected from various impedance characteristics or lengths according to the actual needs of the application scenarios.

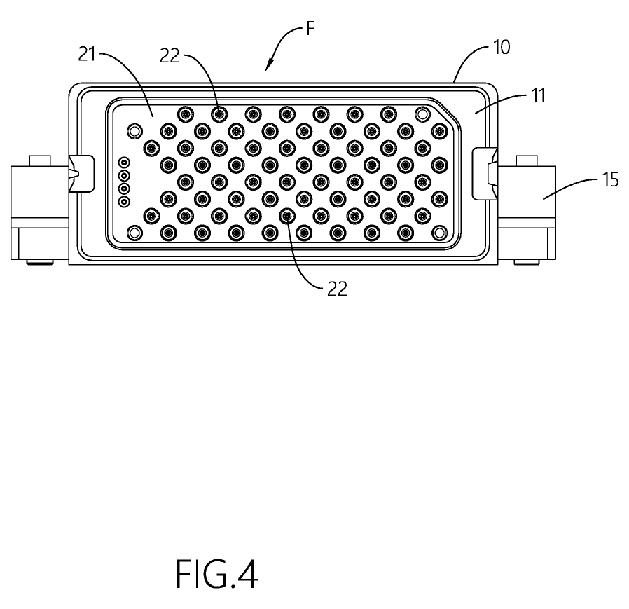

As shown in FIG. 4, the layout of each of the female cable terminals 22 can be varied according to the mode of signal transmission. In this embodiment, the female cable terminals 22 are divided into two groups, an upper group and a lower group, and each of the groups contains a differential pair terminal group and a bypass terminal group respectively, and the differential pair terminal group contains more than one single-ended terminal or differential pair terminal and more than one ground terminal, and the single-ended terminal or differential pair terminal and the ground terminal are arranged alternately in a horizontal direction. Since signal transmission modes vary, the characteristics derived from them are different, so the layout of the female cable terminals 22 can be arranged according to various characteristics and is realized by changing the positions of the terminal holes 213 of the front base 211 and the cable holes of the rear base 212.

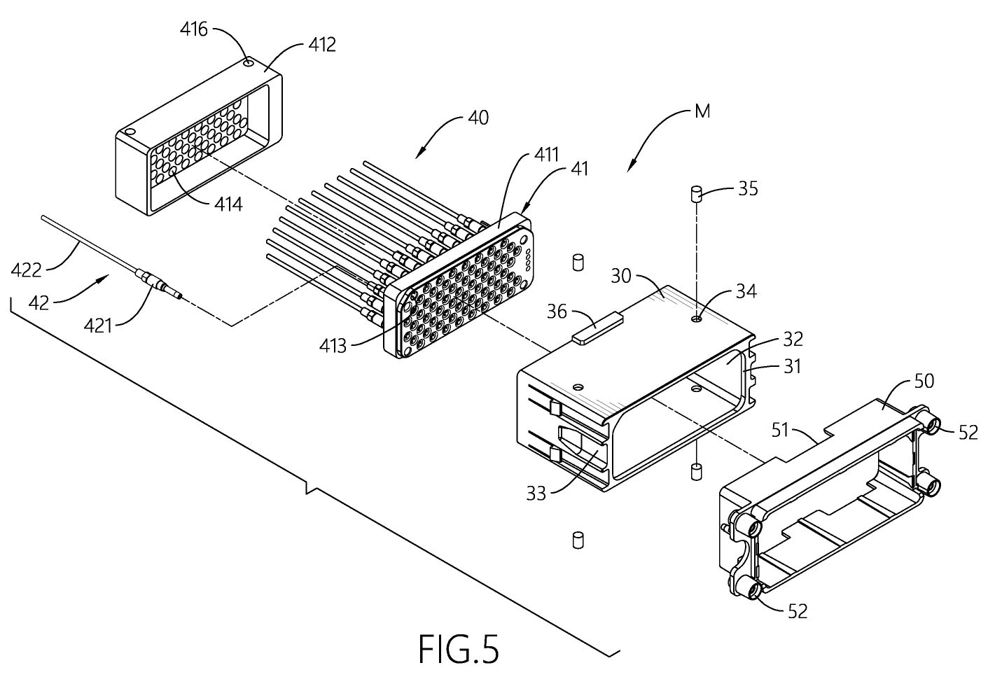

Referring to FIGS. 1 and 5, an embodiment of the present invention is realized in a male connector M, which comprises a male housing 30 and a male cable module 40; wherein, in this embodiment, the male housing 30 mainly comprises a hollow rectangular frame which includes a top portion, a bottom portion, and two side portions, and a ring-shaped frame edge 31 formed at one end of the frame edge 31 towards the docking direction, and an installation slot 32 formed at the inner side of the frame edge 31 for installing the male cable module 40.

Each of the outer surfaces of the two side portions of the male housing 30 is further formed with a respective docking slot 33, and the docking slots 33 correspond to the protrusions 16 of the two side portions of the female housing 10, and guided by the docking slots 33, the male housing 30 is easily inserted into the mating slot 13 of the female housing 10.

Further, the male housing 30 has one or more wedge holes 34 on its top and bottom portions, and each wedge hole 34 is provided with a respective wedge post 35, and the wedge posts 35 can be inserted into the installation slot 32 for fixing the male cable module 40 therebetween.

The male cable module 40 includes a male fixing base 41 and a plurality of male cable terminals 42, the male fixing base 41 is for the plurality of male cable terminals 42 to be mounted thereon, and the male cable module 40 is shape-matched and detachably mounted in the installation slot 32 of the male housing 30. In this embodiment, the male fixing base 41 comprises a front base 411 and a rear base 412 combined with each other, wherein a plurality of terminal holes 413 are formed on the front base 411 and a plurality of cable holes 414 are formed on the rear base 412, and each of the cable holes 414 corresponds to a respective one of the terminal holes 413 of the front base 411, and the front base 411 and the rear base 412 utilize the terminal holes 413 and the cable holes 414 thereon to secure each of the male cable terminals 42.

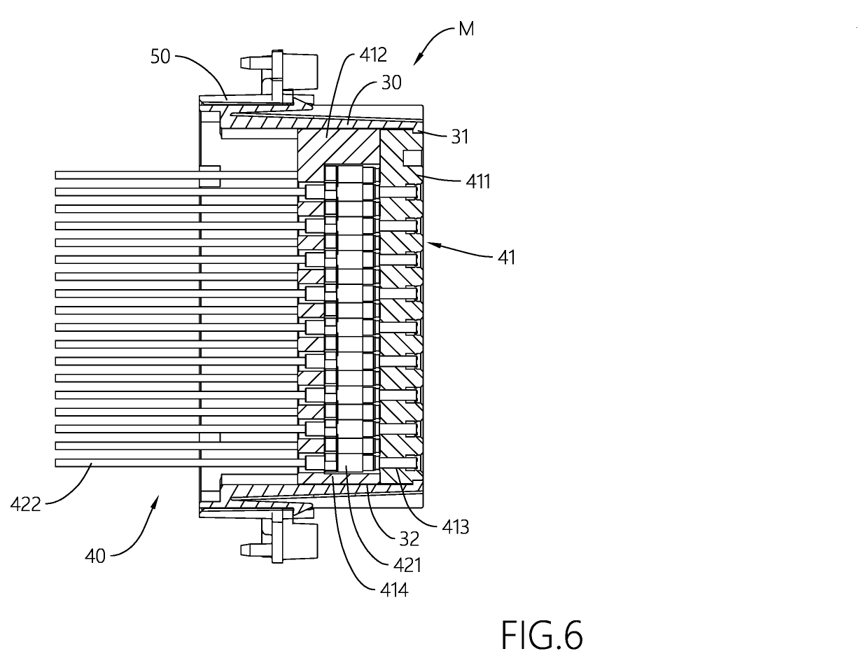

Each of the male cable terminals 42 includes a second terminal head 421 and a coaxial cable 422 respectively. The second terminal head 421 has a mating end and a wire end, the mating end is disposed in and through the terminal hole 413 of the front base 411, and the wire end is engaged with the coaxial cable 422 which is passed through the cable hole 414 of the rear base 412 (as shown in FIG. 6).

Further, the rear base 412 is formed with more than one recessed hole 416 on its top and bottom surfaces respectively, and the recessed holes 416 correspond to the wedge holes 34 on the male housing 30, allowing the wedge posts 35 to be passed through to further strengthen the fixation.

Same as the female connector F, the layout of each of the male cable terminals 42 can be varied according to the mode of signal transmission. In this embodiment, each of the male cable terminals 42 corresponds to one female cable terminal 22 respectively, and the male cable terminals 42 are divided into an upper group and a lower group, and each group contains a differential pair terminal group and a bypass terminal group, and the differential pair terminal group contains more than one single-ended terminal or differential pair terminal and more than one ground terminal, and the single-ended terminals or differential pair terminals and the ground terminals are arranged alternately in a horizontal direction.

Still referring to FIG. 5, to facilitate the fixing of the male connector M, the male connector M further comprises a locking casing 50, which is a hollow rectangular frame, and its internal shape and size are suitably matched with the contour of the male housing 30 and accordingly the locking casing 50 can be snapped onto the male housing 30 to securely combine the male housing 30 with the locking casing 50. In order to securely integrate the male housing 30 with the locking casing 50, the male housing 30 is formed with a block 36 on a rear side of its top surface, and the locking casing 50 is formed with a complementary slot 51 at a corresponding position for mutual engagement.

More than one locking seat 52 is formed on both sides of the locking casing 50 respectively. Each locking seat 52 has a lock hole formed thereon, and the lock hole can be fixed on other carriers with screws or other locking elements.

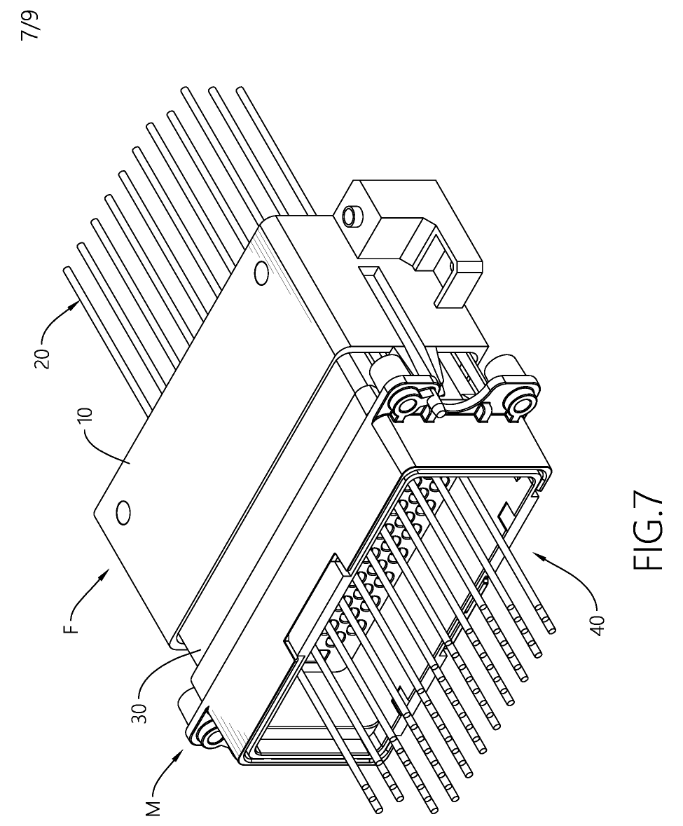

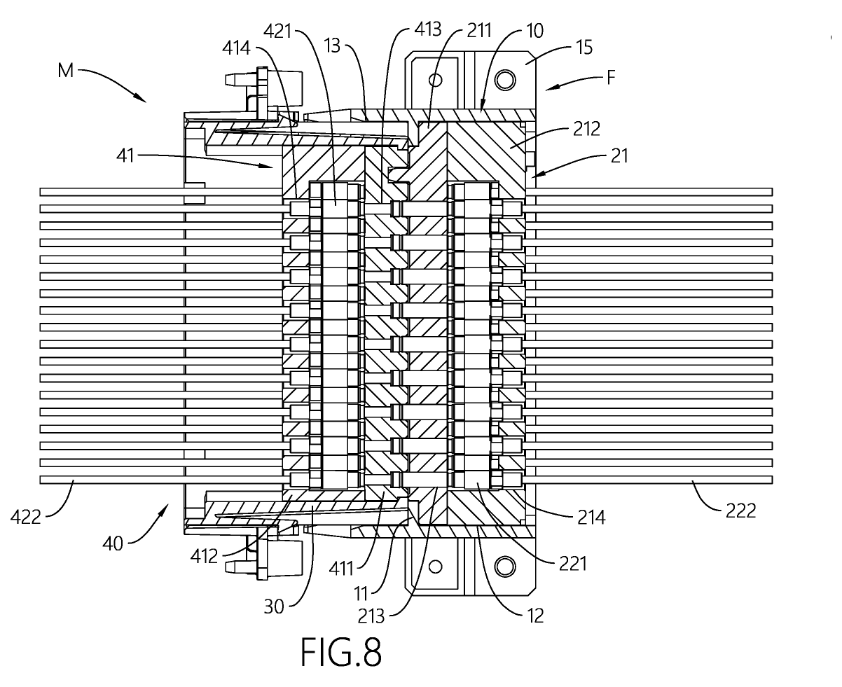

The above description shows the present invention embodied as female connector F and male connector M. FIG. 7 shows the female connector F and male connector M after docked, and as shown in FIG. 8, male connector M is inserted into the mating slot 13 of the female housing 10 with a matching shape of the male housing 30. In this case, the male cable terminal 42 in the male housing 30 is connected with the first terminal head 221 of the female cable terminal 22 in the female housing 10 via the mating end of the second terminal head 421 to form an electrical connection.

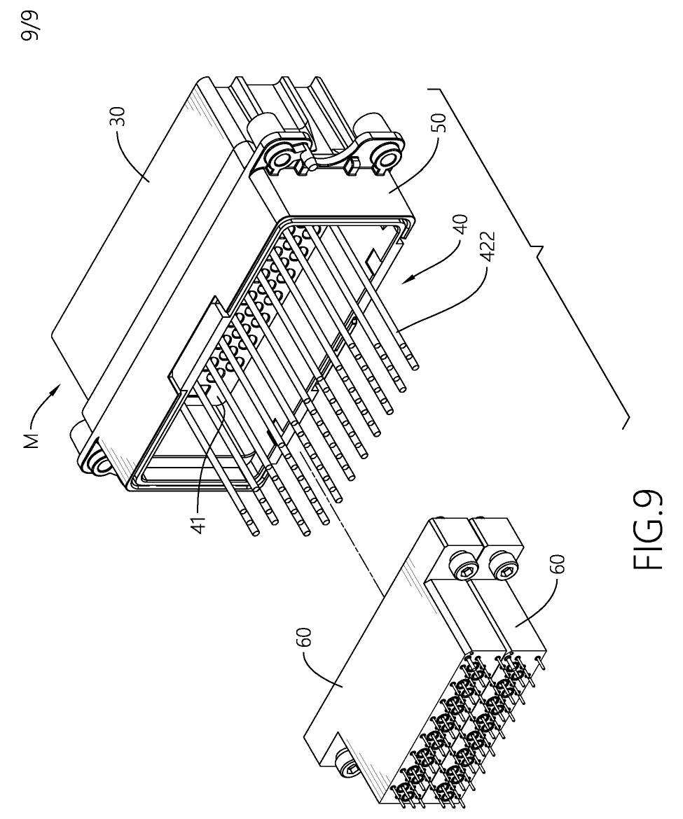

Since the present invention directly uses a coaxial cable as the signal transmission medium on the electrical connection device, the coaxial cable is connected to the terminal in such a way that, in addition to having the other end of the coaxial cable directly soldered to a printed circuit board, the coaxial cable can also be connected to each other through a pogo pin connector located on the terminal. As shown in FIG. 9. which takes the female connector F as an example, the upper and lower female cable terminals 222 of the female connector F are connected to the terminals through pogo pin connectors 60 respectively.

Under the aforementioned modularized design, the main components of female connector F and male connector M are separable and detachable, which means replaceable as needed when certain components are damaged or need to be changed to meet the needs for various characteristics, such that the female cable module 20, the male cable module 40, and their female fixing base 21, female cable terminal 22, male fixing base 41, and male cable terminal 42 used as the main medium for transmitting signals, can be replaced individually to meet the needs for repair and characteristics changes, and furthermore the terminal head and coaxial cable that make up the female cable terminal 22 and male cable terminal 42 can also be individually replaced to meet the needs for repair and characteristics changes.

The technical principles of the present invention are described above in connection with specific embodiments. These descriptions are only intended to explain the principles of the present invention, and are not to be construed in any way as a limitation on the scope of protection of the present invention. Based on the explanations herein, other specific embodiments of the present invention can be associated by those skilled in the art without creative labor, and these equivalent variations or substitutions are included in the scope limited by the claims of this application.

Although the present invention has been disclosed as above by way of a preferred embodiment, it is not intended to limit the present invention, and any one skilled in the art may make certain changes and modifications without departing from the spirit and scope of the present invention, and therefore the scope of protection of the present invention shall be subject to the scope of the appended patent claims as defined herein.

What is claimed is:

1. A modular electrical connection device comprising a connector which comprises:
a housing, being hollow and having an end-to-end installation slot; a cable module having a plurality of cable terminals detachably disposed on a fixing base; wherein the fixing base is shape-matched and detachably disposed within the installation slot of the housing, the fixing base has a plurality of terminal holes; each cable terminal has a terminal head and a coaxial cable, the terminal head has a mating end and a wire end, the mating end is disposed in and through the terminal hole of the fixing base, and the wire end is engaged with the coaxial cable.

2. The modular electrical connection device as claimed in claim 1, wherein the fixing base consists of a front base, a rear base, and a plurality of terminal holes formed on the front base for disposing in and through each of the terminal heads of the cable terminals, and a plurality of cable holes formed on the rear base for each of the coaxial cables of the cable terminals to be passed through.

3. The modular electrical connection device as claimed in claim 2, comprising more than one wedge hole formed on the housing, each of the more than one wedge hole having a respective wedge post, and the wedge post penetrating into the installation slot to secure the fixing base therebetween, more than one recessed hole formed on the fixing base, and the more than one recessed hole corresponding to the more than one wedge hole and the wedge post on the housing.

4. The modular electrical connection device as claimed in claim 1, wherein the cable terminal on the fixing base includes a differential pair terminal group and a bypass terminal group, wherein the differential pair terminal group comprises more than one single-ended terminal or differential pair terminal, and more than one ground terminal, wherein the more than one single-ended terminal or the more than one differential pair terminal is arranged alternately in a horizontal direction.

5. The modular electrical connection device as claimed in claim 1, the connector being a female connector, and the female connector comprising:
a female housing, comprising a top portion, a bottom portion, and two side portions forming an end-to-end hollow rectangular frame, and a ring-shaped frame edge formed in the hollow rectangular frame, the ring-shaped frame edge dividing the interior of the female housing into a front side and a rear side, the front side forming the mating slot, and the rear side forming an installation slot;
each of the inner side walls of the two side portions of the female housing comprising a respective wedge protruding therefrom and into the installation slot to further secure the cable module assembled in the installation slot, and the cable module being a female cable module;
the female cable module comprising a female fixing base and a plurality of female cable terminals, each of the two sides of the female fixing base having a respective wedge slot formed thereon, the wedge slots corresponding to the wedges of the female housing.

6. The modular electrical connection device as claimed in claim 2, the connector being a female connector, and the female connector comprising:
a female housing, comprising a top portion, a bottom portion, and two side portions forming an end-to-end hollow rectangular frame, and a ring-shaped frame edge formed in the hollow rectangular frame, the ring-shaped frame edge dividing the interior of the female housing into a front side and a rear side, the front side forming the mating slot, and the rear side forming an installation slot;
each of the inner side walls of the two side portions of the female housing comprising a respective wedge protruding therefrom and into the installation slot to further secure the cable module assembled in the installation slot, and the cable module being a female cable module;
the female cable module comprising a female fixing base and a plurality of female cable terminals, each of the two sides of the female fixing base having a respective wedge slot formed thereon, the wedge slots corresponding to the wedges of the female housing.

7. The modular electrical connection device as claimed in claim 3, the connector being a female connector, and the female connector comprising:
a female housing, comprising a top portion, a bottom portion, and two side portions forming an end-to-end hollow rectangular frame, and a ring-shaped frame edge formed in the hollow rectangular frame, the ring-shaped frame edge dividing the interior of the female housing into a front side and a rear side, the front side forming the mating slot, and the rear side forming an installation slot;
each of the inner side walls of the two side portions of the female housing comprising a respective wedge protruding therefrom and into the installation slot to further secure the cable module assembled in the installation slot, and the cable module being a female cable module;
the female cable module comprising a female fixing base and a plurality of female cable terminals, each of the two sides of the female fixing base having a respective wedge slot formed thereon, the wedge slots corresponding to the wedges of the female housing.

8. The modular electrical connection device as claimed in claim 4, the connector being a female connector, and the female connector comprising:
a female housing, comprising a top portion, a bottom portion, and two side portions forming an end-to-end hollow rectangular frame, and a ring-shaped frame edge formed in the hollow rectangular frame, the ring-shaped frame edge dividing the interior of the female housing into a front side and a rear side, the front side forming the mating slot, and the rear side forming an installation slot;
each of the inner side walls of the two side portions of the female housing comprising a respective wedge protruding therefrom and into the installation slot to further secure the cable module assembled in the installation slot, and the cable module being a female cable module;
the female cable module comprising a female fixing base and a plurality of female cable terminals, each of the two sides of the female fixing base having a respective wedge slot formed thereon, the wedge slots corresponding to the wedges of the female housing.

9. The modular electrical connection device as claimed in claim 5, wherein on each of the two side portions of the female housing a respective protrusion extends with a tapered end towards a docking direction.

10. The modular electrical connection device as claimed in claim 1, the connector being a male connector, and the male connector comprising:
a male housing comprising a top portion, a bottom portion, and two side portions forming an end-to-end hollow rectangular frame, with a ring-shaped frame edge at one end towards a docking direction and the installation slot formed at an inner side of the frame edge to install the cable module which is a male cable module.

11. The modular electrical connection device as claimed in claim 2, the connector being a male connector, and the male connector comprising:
a male housing comprising a top portion, a bottom portion, and two side portions forming an end-to-end hollow rectangular frame, with a ring-shaped frame edge at one end towards a docking direction and the installation slot formed at an inner side of the frame edge to install the cable module which is a male cable module.

12. The modular electrical connection device as claimed in claim 3, the connector being a male connector, and the male connector comprising:
a male housing comprising a top portion, a bottom portion, and two side portions forming an end-to-end hollow rectangular frame, with a ring-shaped frame edge at one end towards a docking direction and the installation slot formed at an inner side of the frame edge to install the cable module which is a male cable module.

13. The modular electrical connection device as claimed in claim 4, the connector being a male connector, and the male connector comprising:
a male housing comprising a top portion, a bottom portion, and two side portions forming an end-to-end hollow rectangular frame, with a ring-shaped frame edge at one end towards a docking direction and the installation slot formed at an inner side of the frame edge to install the cable module which is a male cable module.

14. The modular electrical connection device as claimed in claim 10, wherein each of outer surfaces of the two side portions of the male housing comprises a respective docking slot formed thereon.

15. The modular electrical connection device as claimed in claim 10, wherein the male connector further comprises a locking casing, which is a hollow rectangular frame, the inner shape and size of the locking casing are matched with contour of the male housing, and the locking casing is configured to be snapped onto the male housing.

16. The modular electrical connection device as claimed in claim 15, wherein the male housing has a block formed on a rear side of its top surface and the locking casing has a complementary slot formed in a corresponding position for mutual engagement.
